(19) United States
(12) Patent Application Publication
(10) Pub. No.: US 2023/0130265 A1
(43) Pub. Date: Apr. 27, 2023

(54) SYSTEMS AND METHODS FOR AUTONOMOUS NAVIGATION AND TRANSPORTATION

(71) Applicant: Nala Robotics, Inc., Arlington Heights, IL (US)

(72) Inventors: Vijay Kodali, Palatine, IL (US); Ajay Kumar Sunkara, South Barrington, IL (US)

(21) Appl. No.: 17/511,846

(22) Filed: Oct. 27, 2021

(51) Int. Cl. G05D 1/02; G05D 1/00; A47J 44/00

(52) U.S. Cl. CPC G05D 1/0291; G05D 1/0088; G05D 1/0212; A47J 44/00

(57) ABSTRACT

Systems and methods for an autonomous navigation and transportation (ANT) system are described. In one embodiment, the ANT system includes stations, ANT vehicles, a pathway infrastructure, and a computing device. The computing device is configured to assign an ANT vehicle a first station and a transportation characteristic. The computing device is also configured to receive a junction signal in response to the ANT vehicle being present at a junction. The computing device is further configured to send a navigation signal to the ANT vehicle to cause the ANT vehicle to travel from the at least one junction. The computing device is configured to receive a destination signal from the ANT vehicle that the ANT vehicle is present at the first station based on a station identifier. The computing device is configured to cause the first station to perform an action relative to the ANT vehicle based on the transportation characteristic.

### BACKGROUND

The Organization for Economic Cooperation and Development found that on average the residents of Western countries spend two hours and eight minutes a day on meal preparation and cleanup. Meal preparation typically includes following a recipe to determine the amounts of ingredients that should be used and how those ingredients should be incorporated during the cooking process. While following the recipe may be repetitive for a person, even slight deviations from the recipe can ruin a meal. Accordingly, people are daily spending a great deal of time on mundane meal preparation that if not performed correctly can lead to detrimental deviations in taste, consistency, and flavor.

### BRIEF DESCRIPTION

According to one aspect, an autonomous navigation and transportation (ANT) system for an automated kitchen is provided. The ANT system includes a plurality of stations, a plurality of self-propelled ANT vehicles, a pathway infrastructure, and a computing device. Each station of the plurality of stations includes a machine-readable station identifier. Each ANT vehicle of the plurality of ANT vehicles includes a machine-readable ANT identifier. The pathway infrastructure in the automated kitchen forms a plurality of paths having at least one junction where a first path of the plurality of paths intersects a second path of the plurality of paths. The computing device is configured to assign an ANT vehicle of the plurality of ANT vehicles a first station associated with at least a first segment of the pathway infrastructure and a transportation characteristic. The computing device is further configured to receive a junction signal in response to the ANT vehicle being present at the at least one junction. The computing device is yet further configured to send a navigation signal to the ANT vehicle to cause the ANT vehicle to travel a next segment from the at least one junction. The computing device is configured to receive a destination signal from the ANT vehicle that the ANT vehicle is present at the first station based on the station identifier. The computing device is further configured to cause the first station to perform an action relative to the ANT vehicle based on the transportation characteristic.

According to another aspect, a computer implemented method for an autonomous navigation and transportation (ANT) system is provided. The computer-implemented method includes assigning an ANT vehicle of a plurality of ANT vehicles a first station of a plurality of stations associated with a pathway infrastructure and a transportation characteristic. Each ANT vehicle of the plurality of ANT vehicles includes a machine-readable ANT identifier. Each station of the plurality of stations includes a machine-readable station identifier. The pathway infrastructure in the automated kitchen forms a plurality of paths and at least one junction where a first path of the plurality of paths intersects a second path of the plurality of paths. The computer-implemented method further includes receiving a junction signal in response to the ANT vehicle being present at the at least one junction. The computer-implemented method yet further includes sending a navigation signal to the ANT vehicle to cause the ANT vehicle to travel a next segment from the at least one junction. The computer-implemented method includes receiving a destination signal from the ANT vehicle that the ANT vehicle is present at the first station based on the station identifier. The computer-implemented method includes causing the first station to perform an action relative to the ANT vehicle based on the transportation characteristic.

According to still another aspect, a non-transitory computer readable storage medium storing instructions that when executed by a computer, which includes a processor perform a method for an autonomous navigation and transportation (ANT) system. The method includes assigning an ANT vehicle of a plurality of ANT vehicles a first station of a plurality of stations associated with a pathway infrastructure and a transportation characteristic. Each ANT vehicle of the plurality of ANT vehicles includes a machine-readable ANT identifier. Each station of the plurality of stations includes a machine-readable station identifier. The pathway infrastructure in the automated kitchen forms a plurality of paths and at least one junction where a first path of the plurality of paths intersects a second path of the plurality of paths. The method further includes receiving a junction signal in response to the ANT vehicle being present at the at least one junction. The method yet further includes sending a navigation signal to the ANT vehicle to cause the ANT vehicle to travel a next segment from the at least one junction. The method includes receiving a destination signal from the ANT vehicle that the ANT vehicle is present at the first station based on the station identifier. The method includes causing the first station to perform an action relative to the ANT vehicle based on the transportation characteristic.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings.

FIG. 1 is a block diagram of an operating environment for systems and methods for an autonomous navigation and transportation (ANT) system according to an exemplary embodiment.

FIG. 2A is a top view of an exemplary automated kitchen for a system for automated cooking, according to one aspect.

FIG. 2B is a perspective view of the exemplary automated kitchen for a system for automated cooking, according to one aspect.

FIG. 3 is a view of an exemplary ANT vehicle for the ANT system, according to one aspect.

FIG. 4 is an exemplary process flow of a method associated with the ANT system, according to one aspect.

FIG. 5 is an exemplary process flow of another method associated with the ANT system, according to one aspect.

FIG. 6 is an exemplary process flow for stages of method associated with the ANT system, according to one aspect.

FIG. 7 is an illustration of an example computer-readable medium or computer-readable device including processor-executable instructions configured to embody one or more of the provisions set forth herein, according to one aspect.

### DETAILED DESCRIPTION

Systems and methods for an autonomous navigation and transportation (ANT) system for an automated kitchen are described herein. The present systems and methods provide for automated cooking that saves the diner time that he would otherwise spend on meal preparation. Furthermore, the automated cooking process results in consistency in maintaining the taste, texture, flavor, and visual appeal of the food. The automated kitchen system can cook an order from a diner by storing and transporting the necessary ingredients for that cuisine and utilizing the ingredients to cook a recipe without human intervention in the cooking process.

However, to offer a variety of meals the automated kitchen may need to stock a number of containers, utensils, ingredients, and cookware. The ANT system is a centralized system for monitoring, transporting, collecting, dispensing, and cooking, among other kitchen related activities. In one embodiment, the ANT system is an intra-kitchen logistics system using ANT vehicles that transport items from one station to another with in the automated kitchen. For example, the ANT vehicles may receive ingredient quantities in a designated container type and carry them to an assigned station. The ANT vehicles then travel throughout the automated kitchen on paths of a pathway infrastructure without interfering with other ANT vehicles or activities in the automated kitchen. This approach improves the movement of ingredients and objects in the automated kitchen, yielding more time efficient, accurate, and organized cooking in a scalable way, which results in consistency.

### Definitions

The following includes definitions of selected terms employed herein. The definitions include various examples and/or forms of components that fall within the scope of a term and that can be used for implementation. The examples are not intended to be limiting. Further, the components discussed herein, can be combined, omitted or organized with other components or into different architectures.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) can reside within a process and/or thread. A computer component can be localized on one computer and/or can be distributed between multiple computers.

“Computer communication,” as used herein, refers to a communication between two or more computing devices (e.g., computer, personal digital assistant, cellular telephone, network device) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, among others. Computer communication can utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Database,” as used herein, is used to refer to a table. In other examples, “database” can be used to refer to a set of tables. In still other examples, “database” can refer to a set of data stores and methods for accessing and/or manipulating those data stores. A database can be stored, for example, at a disk and/or a memory.

“Data store,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

“Display,” as used herein can include, but is not limited to, LED display panels, LCD display panels, CRT display, plasma display panels, touch screen displays, among others, that are often found on portable devices to display information. The display can receive input (e.g., touch input, keyboard input, input from various other input devices, etc.) from a user.

“Input/output device” (I/O device) as used herein can include devices for receiving input and/or devices for outputting data. The input and/or output can be for controlling different features which include various components, systems, and subsystems. Specifically, the term “input device” includes, but it not limited to: keyboard, microphones, pointing and selection devices, cameras, imaging devices, video cards, displays, push buttons, rotary knobs, and the like. The term “input device” additionally includes graphical input controls that take place within a user interface which can be displayed by various types of mechanisms such as software and hardware-based controls, interfaces, touch screens, touch pads or plug and play devices. An “output device” includes, but is not limited to: display devices, and other devices for outputting information and functions.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software-controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Operable connection,” or a connection by which entities are “operably connected,” is one in which signals, physical communications, and/or logical communications can be sent and/or received. An operable connection can include a wireless interface, a physical interface, an optical interface, a data interface, and/or an electrical interface.

“Portable device,” as used herein, is a computing device typically capable of computer communication. The portable device may have a display screen with user input (e.g., touch, keyboard) and a processor for computing. Portable devices include, but are not limited to, handheld devices, mobile devices, smart phones, laptops, tablets and e-readers. In some embodiments, a “portable device” could refer to a remote device that includes a processor for computing and/or a communication interface for receiving and transmitting data remotely. In other embodiments, the portable device may be a device for facilitating remote communication. For example, the portable device may be a key fob that remotely controls the security system including the door locks, alarms, etc.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry, such as a programmable logic controller, to execute actions and/or algorithms.

“Systems,” as used herein can include, but is not limited to, any automatic or manual systems that can be used to enhance the cooking process for example, the station systems, ANT vehicle systems, and/or junction systems. Exemplary robotic systems include, but are not limited to: an electronic mobility and stability control systems, measuring systems (e.g., temperature, weight, volume, area, dimension, etc.), a temperature control system, a lighting system, an audio system, and a sensory system, among others. Exemplary systems include, but are not limited to: an electronic stability control system, a brake assist system, a collision warning system, a collision mitigation braking system, an auto cruise control system, a lane departure warning system, a steering system, a transmission system, and visual devices (e.g., camera systems, proximity sensor systems), among others.

“Vehicle,” as used herein, refers to any self-propelled vehicle that is capable of carrying one or more objects and is powered by any form of energy. The term “vehicle” includes, but is not limited to an un-crewed, self-propelled, land-based craft, aircraft, or watercraft. For example, a vehicle may include all or a portion of a robot, a wheeled craft, single-rotor drone, a multi-rotor drone, a fixed-wing drone, a fixed-wing hybrid drone, a small drone, a micro drone. Further, the term “vehicle” can include vehicles that are automated or non-automated with pre-determined paths or free-moving vehicles.

### I. System Over View

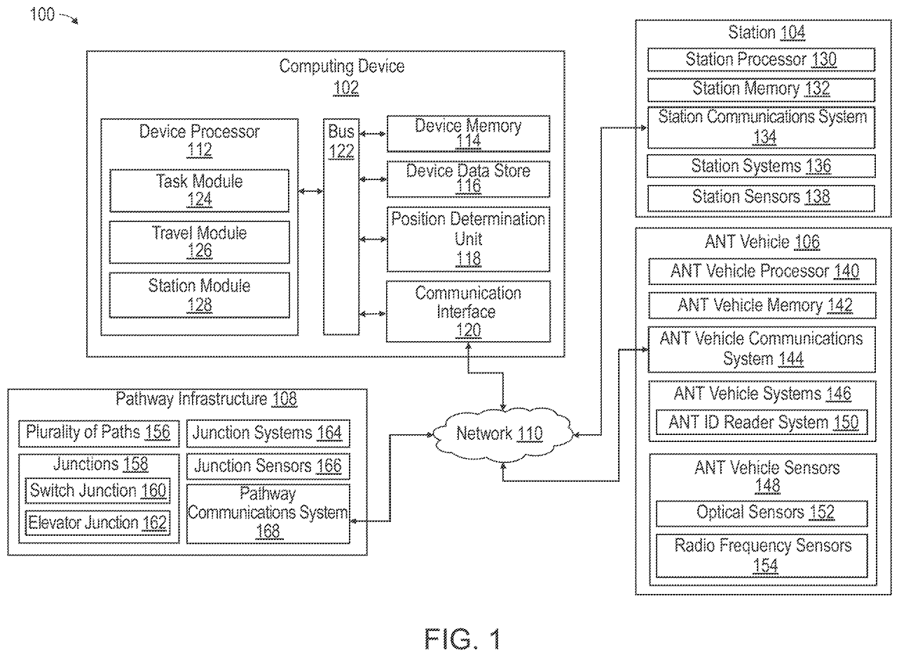

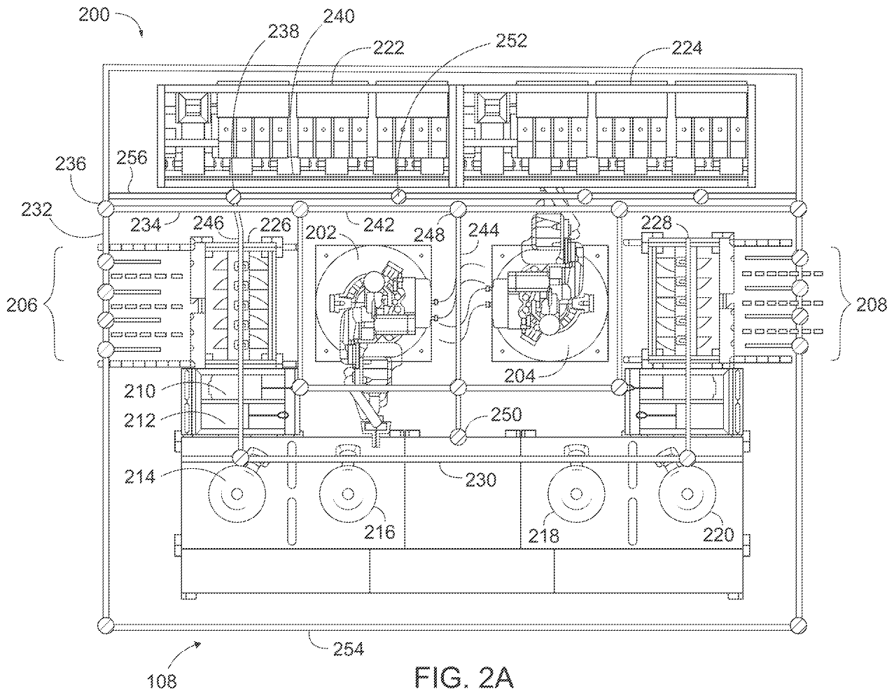

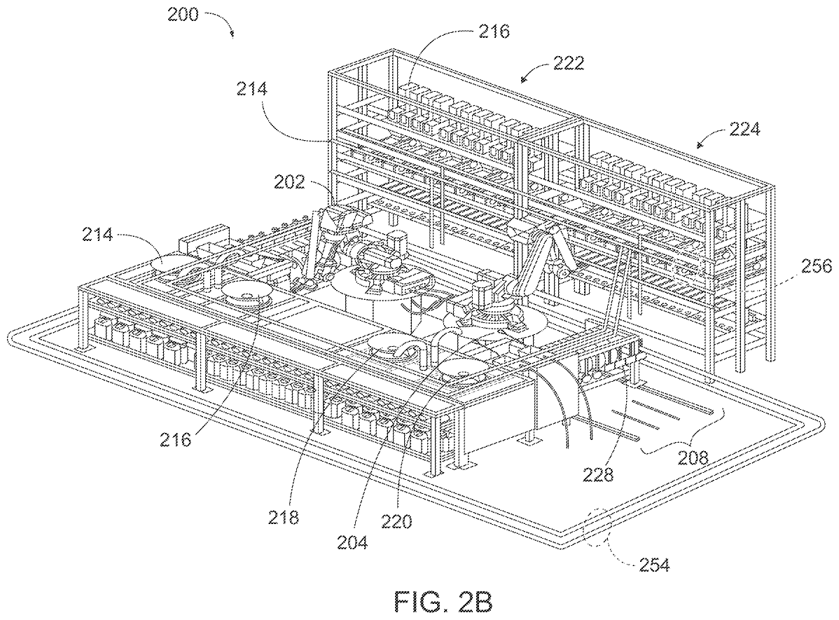

Referring now to the drawings, wherein the showings are for purposes of illustrating one or more exemplary embodiments and not for purposes of limiting same, FIG. 1 is a schematic diagram of an operating environment 100 according to an exemplary embodiment is shown. One or more of the components of the operating environment 100 can be utilized, in whole or in part, with an automated kitchen 200, as shown in the top view of FIG. 2A and the corresponding perspective view of FIG. 2B. The components of the operating environment 100, as well as the components of other systems, hardware architectures, and software architectures discussed herein, may be combined, omitted, or organized into different architectures for various embodiments. The operating environment 100 may be implemented with a device or remotely stored.

The operating environment 100 may include a computing device 102, a station 104 of a plurality of stations, an ANT vehicle 106, and a pathway infrastructure 108 that communicates via a network 110. Generally, the computing device 102 includes a device processor 112, a device memory 114, a device data store 116, a position determination unit 118, and a communication interface 120, which are each operably connected for computer communication via a bus 122 and/or other wired and wireless technologies defined herein. The computing device 102, can include provisions for processing, communicating, and interacting with various components of the operating environment 100. In one embodiment, the computing device 102 can be implemented with the ANT vehicle 106, for example, as part of a telematics unit, a head unit, an electronic control unit, an on-board unit, or as part of a specific robotic system, among others. In other embodiments, the computing device 102 can be implemented remotely, for example, with a remote system (not shown) or a portable device (not shown) connected via the network 110.

The device processor 112 can include logic circuitry with hardware, firmware, and software architecture frameworks for automated cooking. Thus, in some embodiments, the device processor 112 can store application frameworks, kernels, libraries, drivers, application program interfaces, among others, to execute and control hardware and functions discussed herein. For example, the device processor 112 can include a task module 124, a travel module 126, and a station module 128, although the device processor 112 can be configured into other architectures. Further, in some embodiments, the device memory 114 and/or the device data store 116 can store similar components as the device processor 112 for execution by the device processor 112.

The modules of the device processor 112 may access the position determination unit 118 via the bus 122. The position determination unit 118 can include hardware (e.g., sensors) and software to determine and/or acquire position data about various components of the operating environment 100, such as the ANT vehicle 106. For example, the position determination unit 118 can include a positioning system (not shown) and/or an inertial measurement unit (IMU) (not shown). Further, the position determination unit 118 can provide dead-reckoning data or motion data from, for example, a gyroscope, accelerometer, magnetometers, among other sensors, such as the ANT vehicle sensors 148.

The communication interface 120 can include software and hardware to facilitate data input and output between the components of the computing device 102 and other components of the operating environment 100. Specifically, the communication interface 120 can include network interface controllers (not shown) and other hardware and software that manages and/or monitors connections and controls bi-directional data transfer between the communication interface 120 and other components of the operating environment 100 using, for example, the network 110.

The station 104 is an exemplary embodiment of a station of the plurality of stations. The station 104 may include a station processor 130, a station memory 132, a station communications system 134, station systems 136, and station sensors 138 that facilitate a task, such as docking, ingredient storage, utensil storage, cooking, and cleaning, among others. For example, turning to FIG. 2A and FIG. 2B, the automated kitchen 200 may include a plurality of stations plurality of stations such as a first robotic station 202, a second robotic station 204, a first docking station 206, a second docking station 208, a first fry station 210, a second fry station 212, a first cookware station 214, a second cookware station 216, a third cookware station 218, a fourth cookware station 220, a first ingredient station 222, a second ingredient station 224, a first cleaning station 226, and a second cleaning station 228.

The stations of the plurality of stations may be associated with a station category of a plurality of station categories. For example, the robotic station category may include the first robotic station 202 and the second robotic station 204. The docking station category may include the first docking station 206 and the second docking station 208. A cooking station category may include the first fry station 210, the second fry station 212, the first cookware station 214, the second cookware station 216, the third cookware station 218, and the fourth cookware station 220. An ingredient storage category may include the first ingredient station 222 and the second ingredient station 224. A cleaning station category may include the first cleaning station 226 and the second cleaning station 228.

The station 104 is an exemplary station and may include, in whole or in part, such as robotic arms, end effectuators, a cooking surface, a liquid dispenser, and/or a storage unit, among others that are controlled by the station processor 130, the station memory 132, the station communications system 134, the station systems 136, and/or the station sensors 138. The station systems 136 can include any type of robotic control system and/or component of the automated kitchen 200. The station sensors 138 may include sensors for collecting data. The station processor 130, the station memory 132, the station communications system 134, the station systems 136, and the station sensors 138 may be situated in a single station or distributed among multiple stations of the plurality of stations. Accordingly one or more stations of the plurality of stations may include the station processor 130, the station memory 132, the station communications system 134, the station systems 136, and the station sensors 138

Returning to FIG. 1, the ANT vehicle 106 include an ANT vehicle processor 140, an ANT vehicle memory 142, an ANT vehicle communications system 144, ANT vehicle systems 146, and ANT vehicle sensors 148. The ANT vehicle 106 is a self-propelled vehicle that moves about the automated kitchen 200. The ANT vehicle systems 146 can include any type of control system and/or component of the automated kitchen 200 to enhance the ANT vehicle 106. For example, the ANT vehicle systems 146 can include measuring systems, electronic mobility control, electronic stability control, etc. The ANT vehicle systems may include an ANT ID reader system 150 that allows the ANT vehicle 106 to process identifiers of other objects in the pathway infrastructure 108. As will be described, one or more of the ANT vehicle systems 146 can be controlled remotely according the systems and methods discussed herein.

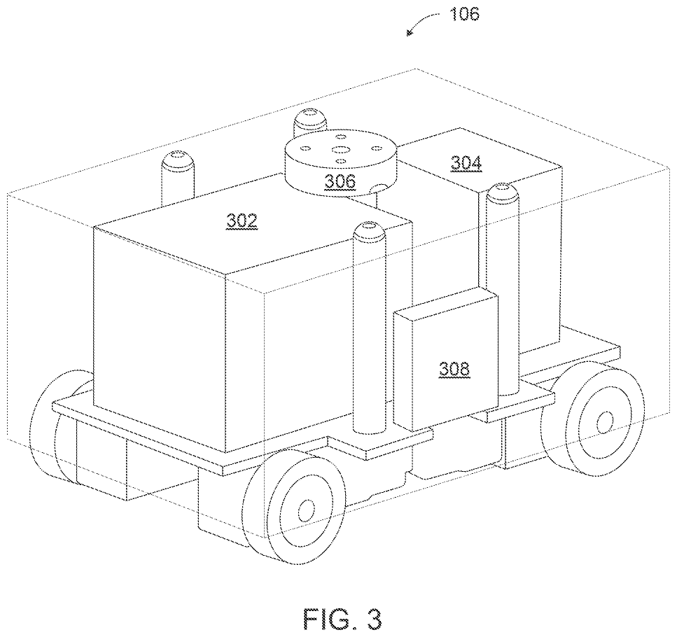

Turning to FIG. 3, an example embodiment of an ANT vehicle 106 is shown. The ANT vehicle includes a controller 302, including the ANT vehicle processor 140 and the ANT vehicle memory 142, a battery 304, the optical sensors 152, such as a LIDAR sensor 306, and the radio frequency sensor 154, such as the identification reader 308. The ANT vehicle 106 may be powered entirely or partially by one or more electric motors powered by the battery 304. The battery 304 may be configured to receive charging power to charge the battery 304 via a charging link at the first docking station 206 or the second docking station 208. The first docking station 206 and/or the second docking station 208 may be operably connected for computer communication with the computing device 102 and/or the ANT vehicle 106, for example, to transmit and receive data (e.g., charge parameters, positioning at the first docking station 206 and/or the second docking station 208). The charging link may be a wired or wireless link.

Returning to FIG. 1, the pathway infrastructure 108 includes a plurality of paths 156 that intersect at one or more junctions 158 such as a switch junction 160 or an elevator junction 162 as will be discussed below. The pathway infrastructure 108 may further include junction systems 164, junction sensors 166, and a pathway communications system 168 that are configured to be in communication with one another. In some embodiments, the pathway infrastructure 108 can receive and transmit information to and from the computing device 102 and/or the ANT vehicle 106 including, but not limited to delivery data, task data, feedback data, etc.

As shown in FIG. 2A and FIG. 2B, the plurality of paths 156 of the automated kitchen may be at floor level and/or elevated. A ground path 254 may move around the plurality of stations, while an elevated path may climb or extend over the plurality of stations. A first elevated path 256 may run parallel to the ground path 254 at a first altitude. For example, suppose that the first elevated path 256 is adjacent the first ingredient station 222 and the second ingredient station 224. The first altitude may raise the ANT vehicle 106 to a height designed for the ANT vehicle 106 to receive an ingredient from a storage container of the first ingredient station 222. A second elevated path 230 is suspended over the first cookware station 214, the second cookware station 216, the third cookware station 218, and the fourth cookware station 220. The second elevated path 230 may run parallel to the ground path 254 at a second altitude configured for dispensing the ingredient into cookware of the first cookware station 214.

The plurality of paths 156 may include one or more of wired pathways that transmit a radio frequency signal, colored tape paths, magnetic tape paths, laser target paths, railways, landmark. For example, the ground path 254 may be a wired pathway while the first elevated path 256 and the second elevated path 230 may utilize magnetic tape. The pathway infrastructure 108 may include remote devices that facilitate transportation throughout the automated kitchen. For example, the pathway infrastructure 108 may include transponders along and/or within paths that can verify the presence of the ANT vehicle 106. Additionally, the ANT vehicle sensors 148 including ranging sensors, gyroscopes, the optical sensors 152, etc. that collect path data as the ANT vehicle 106 travels. The travel module 126 may receive the path data to path plan for the ANT vehicle 106.

The travel module 126 may path plan for the ANT vehicle 106 by defining a route comprised of one or more path segments. Suppose, that the travel module 126 generates route from an origin, the first docking station 206, to a destination, an upper level of the first ingredient station 222. The route may include a first path 232 and a second segment 234 to the first elevated path 256. The travel module 126 may transmit a deploy signal to the ANT vehicle 106 that causes the ANT vehicle to traverse the first path 232 from the first docking station 206 to a first switch junction 236. A switch junction separates at least two paths that are coplanar in that they extend in the same plane. When the ANT vehicle 106 reaches the first switch junction 236 a junction sensor of the junction sensors 166 may detect the ANT vehicle 106. An ANT identification (ID) reader system of the junction systems 164 may identify the ANT vehicle 106 based on junction data from the junction sensors 166 and transmit the junction data to the travel module 126. In response to receiving the junction data and identity of the ANT vehicle 106, the travel module 126 may transmit a deploy signal causing the ANT vehicle 106 to traverse the second segment.

The travel module 126 may send a pause signal causing the ANT vehicle 106 to pause at the first switch junction 236. The ANT vehicle 106 may pause for a predetermined amount of time, until a deploy signal is received at the ANT vehicle 106, or until the junction sensors 166 detect that another ANT vehicle has passed, among other stimuli. In this manner, the travel module 126 may manage traffic of the plurality of ANT vehicles throughout the automated kitchen by causing the ANT vehicle 106 to move and pause at the junctions 158.

In another embodiment, the travel module 126 may cause the ANT vehicle 106 to continue traveling the route from the first path 232 to the second segment 234 through the first switch junction 236 without stopping unless the ANT vehicle 106 receives the pause signal. In yet another embodiment, the first switch junction 236 may physically restrain the ANT vehicle 106 until the junction systems 164 receive a release signal from the travel module 126 via the pathway communications system 168. For example, the first switch junction 236 may include a gate that obstructs the ANT vehicle 106. In response to receiving the release signal, the junction systems 164 may cause the gate to open (e.g., pivot, lift, etc.), thereby allowing the ANT vehicle to proceed to the second segment.

Continuing the example from above, suppose that the ANT vehicle 106 receives the deploy signal and consequently traverses the second segment 234 from the first switch junction 236 to a first elevator junction 238. An elevator junction separates two paths that extend in different planes. For example, the ground path 254 is defined by a first plane and the first elevated path 256 is defined by a second plane vertically separated from the first plane.

In a similar manner as described above, when the ANT vehicle 106 reaches the first elevator junction 238, a junction sensor of the junction sensors 166 may detect the ANT vehicle 106. An ANT identification (ID) reader system of the junction systems 164 may identify the ANT vehicle 106 based on junction data from the junction sensors and transmit the junction data to the travel module 126. In response to receiving the junction data and identity of the ANT vehicle 106, the junction systems 164 may cause the first elevator junction 238 to lift the ANT vehicle 106 to the first elevated path 256. In this manner, the first elevator junction 238 can lift or lower the ANT vehicle 106 between ground level and the first altitude, the second altitude, etc.

The station sensors 138, the ANT vehicle sensors 148, and/or the junction sensors 166, can include various types of sensors for detecting and/or sensing a parameter of the associated with automated cooking. For example, the ANT vehicle sensors 148 can provide data about ingredients, cooking, recipes, tasks, and/or various components of the operating environment 100. In one example, the ANT vehicle 106 may include an ANT identification (ID) reader system for identifying objects, such as the station 104 and/or the junctions 158. Accordingly, the ANT vehicle sensors 148 may include optical sensors 152 and/or radio frequency sensors 154 for sensing an identifier on an object. Additionally, the station sensors 138, the ANT vehicle sensors 148, and/or the junction sensors 166 may also include, but are not limited to: acceleration sensors, speed sensors, braking sensors, proximity sensors, and vision sensors, among others. Accordingly, the ANT vehicle sensors 148 can be any type of sensor, for example, acoustic, electric, environmental, optical, imaging, light, pressure, force, thermal, temperature, and/or proximity, among others.

Using the system and network configuration discussed above, the robotic devices of the automated kitchen 200 can be controlled to perform automated cooking tasks without human intervention. Detailed embodiments describing exemplary methods using the system and network configuration discussed above will now be discussed in detail.

### II. Methods for an ANT System

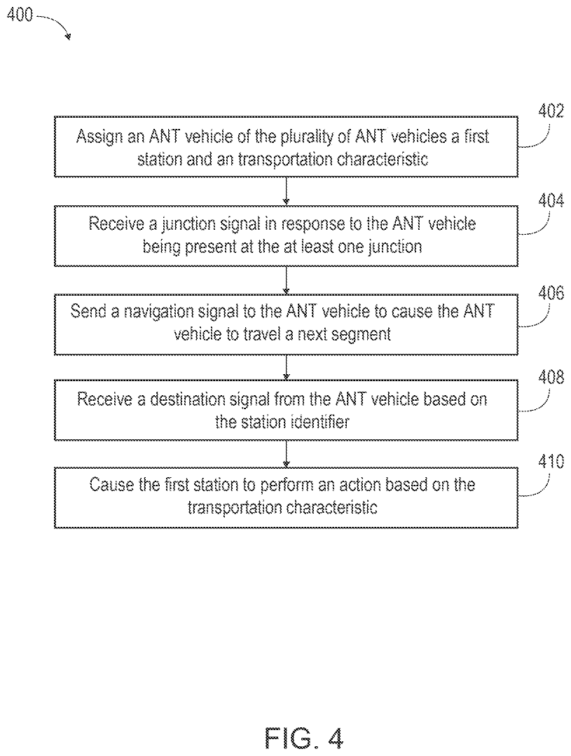

Referring now to FIG. 4, a method 400 for automated cooking will now be described according to an exemplary embodiment. FIG. 4 will also be described with reference to FIGS. 1-3. For simplicity, the method 400 will be described by the following steps, but it is understood that the elements of the method 400 can be organized into different architectures, blocks, stages, and/or processes.

At block 402, the method 400 includes the task module 124 assigning an ANT vehicle 106 of a plurality of ANT vehicles a first station of the plurality of stations and a transportation characteristic. In particular, task module 124 determines the location and the transportation characteristic based on a set of instruction associated with a recipe.

Suppose that a user inputs an order for a food item. The task module 124 may query the computing device 102, remote system (not shown), or recipe database (not shown) for the one or more recipes associated with the food items included in the order. The recipe includes a set of instructions for preparing the at least one food item including a number of steps to facilitate preparation of the food item, for example, stove ignition, preheating, flame control, ingredient identification, ingredient collection instructions, utensil selection, and cooking manipulations (e.g., mix, fold, pour, flip, etc.), among others. The steps may further include location of objects such as ingredients, containers, cookware, utensils, etc. The locations may include identifiers for compartments of the stations, thereby identifying a station and a specific location at the station that corresponds to the resting place of an object.

For example, identifying the first station, the task module 124 may identify a specific compartment. In one embodiment, the first ingredient station 222 and the second ingredient station 224 may include a plurality of compartments. For example, the first ingredient station 222 and the second ingredient station 224 may be separated into sections based on the type of ingredient (e.g., spice, vegetable, fruit, meat, dairy, frozen, etc.). The locations of ingredients based on position values of the containers and relative distance values to other containers may be stored in the device memory 114 and/or the device data store 116 accessible by the task module 124.

The set of instructions of the recipe may link each ingredient to a position in the first ingredient station 222 or the second ingredient station 224. The compartments of the first ingredient station 222 and/or the second ingredient station 224 may delineated based on the type of ingredient (e.g., wet ingredient, dry ingredient, meat, vegetable, etc.). The compartments of the ingredient stations may also be delineated based on the environmental needs of the ingredients. For example, some compartments may be room temperature, refrigerated to preserve ingredients like meat and vegetables, or frozen.

Alternatively, the ingredient may be identified in the recipe and the task module 124 may identify the associated location of the ingredient. For example, the locations of the ingredients in the first ingredient station 222 and/or the second ingredient station 224 may be stored in the device memory 114, the device data store 116, or the station memory 132. The locations may be stored in a database or a look-up table. Suppose that the ingredient, potatoes, is recited in the recipe. The task module 124 may determine that potatoes are located in a particular compartment of the first ingredient station 222, for example, first compartment 240.

The task module 124 may also identify at least one transportation characteristic. For example, the set of instructions may further include type of ingredient (e.g., solid, liquid, powder), a container or cookware (e.g., bowl, flask, cup measurement, etc.) associated with the type of ingredient, weight, cooking times, serving instruction, flame temperature, among others. The set of instructions may include details for the food item, such as the ingredients for the food item, a quantity (e.g., number, weight, volume, etc.) of each ingredient, dispensing requirements for an ingredient, a sequence of operations to be performed in the automated kitchen 200, necessary utensils and/or cookware, and any related activities to prepare the food item. For example, that the ingredient balsamic vinegar is associated with the cookware, a liquid receptacle. In some embodiments, the task module 124 may transmit multiple transportation characteristics. For example, the transportation characteristic may include a liquid receptacle and a volume of liquid.

In some embodiments, the steps may include multiple actions and therefore, multiple locations, weight, cooking times, etc. The set of instructions may also include path plans, timing data, etc. For example, the pathway infrastructure 108 may be mapped to a coordinate system. The set of instructions may include precise coordinates or differential coordinates that dictate movements.

Based on the identification of the location and transportation characteristic, the task module 124 assigns the ANT vehicle 106 a first station and a transportation characteristic. For example, the ANT station may be assigned the first cleaning station 226 as the first station and a liquid receptacle as the transportation characteristic. Assigning the ANT vehicle 106 the first cleaning station 226 and a liquid receptacle as the transportation characteristic may include transmitting the identified station and the transportation characteristic to the ANT vehicle as task data. For example, the task data may include a location of the first station as coordinate data, a location as a specific compartment, such as the first compartment 240, a compartment identifier, at least a portion of a route to the first station, a station identifier for the first station, an object identifier, etc. In some embodiments, the first station may be stored as the route or at least one segment of the route to the first station. The task data may also be transmitted with an ANT vehicle identifier identifying a specific ANT vehicle, for example, using an ANT vehicle identifier.

Identifiers, such as the station identifier, the compartment identifier, the ANT vehicle identifier, the junction identifier and the object identifier, may be electronic data, read alpha-numeric identifiers, quick response (QR) codes, radio frequency identification (RFID), bar codes, labels, tags, etc. such that the identifiers are machine-readable. The identifiers may be machine readable by sensors. For example, station identifier may be an RFID tag at the corresponding station that can be detected by the radio frequency sensors 154 of the ANT vehicle 106. In one embodiment, the task module 124 may transmit the station identifier as the first station. In response, the ANT vehicle 106 may determine a location of the first station from a look-up table based on the station identifier. Then when the ANT vehicle 106 arrives at the location (e.g., station, junction, segment, path, etc.), the radio frequency sensors 154 may detect the station identifier on a tag at the first station.

In another embodiment, the task module 124 may assign the ANT vehicle 106 a first station as a category of station. For example, rather than assigning the ANT vehicle 106 the first cleaning station 226 or the second cleaning station 228, the task module 124 may assign the ANT vehicle 106 a first station as a station category, here, the cleaning station category. In response to receiving the assignment of the cleaning station category, the ANT vehicle 106 may proceed to the first cleaning station 226 or the second cleaning station 228 based on proximity, the status of the first cleaning station 226 and the second cleaning station 228, traffic on the pathway infrastructure 108, etc.

In some embodiments, the task module 124 assigns the ANT vehicle 106 a first station and a transportation characteristic by storing the first station and the transportation characteristic with the ANT vehicle identifier. Suppose the ANT vehicle identifier is an RFID tag. The task module 124 may store the first station and/or the transportation characteristic in the RFID tag such that, when read, the first station and/or the transportation characteristic can be identified. Therefore, when the station sensors 138 and/or the junction sensors 166 may include a junction identification reader to read the RFID tag, the first station and/or the transportation characteristic is discernable. For example, in response to detecting the RFID tag, the station systems 136 and/or the junction systems may access the device memory 114, the device data store 116, and/the task module 124 via the network 110 to identify the first station and/or the transportation characteristic based on the ANT vehicle identifier. In one embodiment, the first station and/or the transportation characteristic may be identified based on a stored look-up table.

The assignment may additionally or alternatively, be transmitted from the task module as a deploy signal. For example, the task module 124 may path plan for the ANT vehicle 106 based on the current location of the ANT vehicle 106. Suppose that the ANT vehicle 106 is docked at the first docking station 206 and the first station is the first cleaning station 226. The task module 124 may plan a route from the first docking station 206 to the first cleaning station 226. The route may include at least one segment, such as the first path 232. The deploy signal may include coordinates of a location associated with a task or ingredient, a route, or the at least one segment. The deploy signal may cause the ANT vehicle 106 to traverse the first path 232.

The travel module 126 may determine a number of segments that comprise the route based on the transportation characteristic. The task module 124 may then transmit the route as the first path 232, a third path 242, a fourth path 244, the second elevated path 230, and a third elevated path 246. The task module 124 may include a number of junctions as the route. For example, the route may be included in the task data as the first switch junction 236, a second switch junction 248, a second elevator junction 250 and a third switch junction 252. In such an embodiment, the deploy signal may cause the ANT vehicle 106 to traverse the pathway infrastructure 108 until the ANT vehicle 106 reaches the first switch junction 236. Accordingly, the route on the pathway infrastructure 108 may include a number of segments corresponding to paths of the plurality of paths 156 and/or a number of junctions 158.

The travel module 126 may track the progress of the ANT vehicle 106 throughout the pathway infrastructure 108 using the various sensors throughout the automated kitchen 200 and/or the position determination unit 118, such as the station sensors 138, the ANT vehicle sensors 148, and/or the junction sensors 166. By tracking the plurality of ANT vehicles throughout the automated kitchen 200, the travel module can path plan with the goal of managing traffic throughout the automated kitchen. Accordingly, the path planning may be based on the location of the other ANT vehicles of the plurality of ANT vehicles on the pathway infrastructure 108.

At block 404, the method 400 includes the travel module 126 receiving a junction signal in response to the ANT vehicle being present at the at least one junction. Suppose, the ANT vehicle 106 reaches the first switch junction 236, the first switch junction 236 may detect the ANT vehicle 106 based on the ANT vehicle identifier of the ANT vehicle 106. For example, the junction sensors 166 may include a radio frequency sensor to identify the ANT vehicle 106. The pathway communications system 168 may transmit the vehicle identity of the ANT vehicle 106 to the travel module 126 as the junction signal. The junction signal indicates the presence of the ANT vehicle 106 at a junction.

In another embodiment, the ANT vehicle 106 may transmit the junction signal in response to the ANT vehicle sensors 148 detecting a junction identifier of, for example, the first switch junction 236. Turning to FIG. 3, an example embodiment of the ANT vehicle 106 is shown. The ANT vehicle 106 may be a wheeled, self-propelled, autonomous vehicle. For example, the ANT vehicle 106 may include controller 302, battery 304, optical sensors 152, such as a LIDAR sensor 306, and radio frequency sensors 154, such as an identification reader 308. The ANT vehicle 106 may also include one or more motors (not shown) driven the controller 302. The instructions for the ANTS target coordinates, target weights to be collected and traffic management information will be transmitted by the computing device 102 via the network 110 and be received by the controller 302.

The ANT vehicle 106 may transmit the junction signal in response to the identification reader 308 detecting a junction identifier. For example, the first switch junction 236 may include a gate with a QR code. In response to the identification reader 308 reading the QR code, the controller 302 transmits the junction signal indicating that the ANT vehicle 106 is present at the first switch junction 236 to the travel module 126 via the network 110. The controller 302 may transmit the junction identifier of the junction 158 to the travel module 126 as the junction signal. In this manner, detection of the ANT vehicle identifier and/or the junction identifier is a trigger event that results in the travel module 126 receiving the junction signal from junction 158 and/or the ANT vehicle 106, respectively.

Returning to FIG. 4, at block 406, the method 400 includes the travel module 126 sending a navigation signal to cause the ANT vehicle 106 to travel a next segment from the at least one junction. Continuing the example from above, suppose the ANT vehicle 106 is at or approaching the first switch junction 236. The travel module 126 may send a navigation signal that causes the ANT vehicle 106 to traverse the third path 242 and/or proceed to the second switch junction 248.

The next segment of path may be predetermined by the travel module 126 as a portion of the route. For example, as described above, the travel module 126 may generate a number of candidate segments associated with one or more routes for the ANT vehicle 106. When the ANT vehicle 106 reaches a junction, such as the first switch junction 236, the travel module 126 is triggered to select a next segment from the number of candidate segments. In this manner, the detection of the ANT vehicle 106 by the junction sensors 166 of the first switch junction 236 may be the trigger event that causes the travel module 126 to select the next segment.

The selection of the next segment may be based on a number of travel parameters such as shortest distance, fastest time, least amount of traffic, charge parameters, etc. In some embodiments, the selection of the next segment may be based on real-time sensor data associated with the pathway infrastructure 108. The travel module 126 may receive sensor data from the sensors. The travel module 126 may identify objects such as other ANT vehicles based on the sensor data using image processing techniques, such as object recognition. For example, the travel module 126 may identify traffic on the pathway infrastructure 108, based on communications with other ANT vehicles, such as deploy signals, junction signals, destinations signals, etc. In another embodiment, sensor data from the junction sensor 166 may indicate that another ANT vehicle is present at the first switch junction 236. Accordingly, the travel module 126 may select a next segment of the route from a number of candidate segments to avoid congestion at the first switch junction 236. In this manner, the travel module 126 may react in real-time. Thus, the next segment may be determined by the travel module 126 in real-time based on the current traffic of the plurality of ANT vehicles on the pathway infrastructure 108.

In some embodiments, the travel module 126 sends a navigation signal to the junction. For example, the first switch junction 236 may include a mechanical device that allows the ANT vehicle 106 to pass through the first switch junction 236 or diverts the ANT vehicle 106 onto a certain path away from the first switch junction 236. In response to the receiving the navigation signal, the first switch junction 236 may activate allowing the ANT vehicle 106 to pass through or be diverted to the next segment. In another embodiment, the first elevator junction 238 may include a raising or lowering device that allows the ANT vehicle 106 to travel vertically to the next segment that is vertically different from the previous segment. In response to the receiving the navigation signal, the first elevator junction 238 may activate carrying the ANT vehicle 106 to the different vertical level.

In another embodiment, the travel module 126 sends then deploy signal to the ANT vehicle 106 to cause the ANT vehicle 106 to move to the next segment. For example, the controller 302 may receive the navigation signal and engage the motor (not shown) of the ANT vehicle 106 to propel itself along the next segment. In one example, the navigation signal may cause the ANT vehicle 106 to engage the first elevator junction 238, for example by moving to a platform, housing, or other object capable of carrying the ANT vehicle 106. Engaging the first elevator junction 238 may automatically cause the first elevator junction to move to the different vertical level where the ANT vehicle 106 proceeds to the next segment.

At block 408, the method 400 includes receiving a destination signal from the ANT vehicle that the ANT vehicle is present at the first station based on the station identifier. Continuing the example from above, suppose that the task module 124 plans a route from the first docking station 206 to the first cleaning station 226. In a similar manner as described with respect to the junctions 158, the ANT vehicle sensors 148 may detect a station identifier. For example, the identification reader 308 may read the QR code at the destination, such as the first cleaning station 226. The controller 302 transmits the destination signal indicating that the ANT vehicle 106 is present at the destination, here the first cleaning station 226, to the travel module 126 via the network 110.

In another embodiment, the computing device 102 may receive the destination signal from the destination, such as a station 104. For example, when the ANT vehicle 106 reaches the first cleaning station 226, the first cleaning station 226 may detect the ANT vehicle 106 based on the ANT vehicle identifier of the ANT vehicle 106. The station sensors 138 may include a radio frequency sensor to identify the ANT vehicle 106. The station systems 136 may transmit the vehicle identity of the ANT vehicle 106 to the travel module 126 as the destination signal. The destination signal indicates the presence of the ANT vehicle 106 at the destination, here the first cleaning station 226.

At block 410, the method 400 includes the station module 128 causing an action to be performed between the first station and the ANT vehicle 106 based on the transportation characteristic. The station module 128 may cause the first station to perform the action by transmitting an object signal to the first station. For example, suppose the transportation characteristic is a type of cookware, such as a 7-inch bowl. The station module 128 may cause the first cleaning station 226 to dispense a 7-inch bowl to the ANT vehicle 106 by sending the first cleaning station 226 an object signal.

In some embodiments, the first station may make an object or ingredient available to the ANT vehicle 106, for example, by pushing the object forward, bringing the object to the front, moving compartments to bring a specific compartment forward. In another embodiment, the first station may make a compartment with the object accessible, such as opening a compartment door. The ANT vehicle 106 may include a receiving apparatus configured to receive a number of objects such as cookware, utensils, ingredients, prepared food items etc. For example, the first cleaning station 226 may make the 7-inch bowl available to the ANT vehicle 106 by moving the bowl, components of the first cleaning station 226. Accordingly, in response to the station module 128 causing the first station to perform an action relative to the ANT vehicle 106 based on the transportation characteristic, the ANT vehicle 106 may receive an object. In another embodiment, the ANT vehicle 106 may perform the action, such as dispensing an ingredient to the cookware station 214.

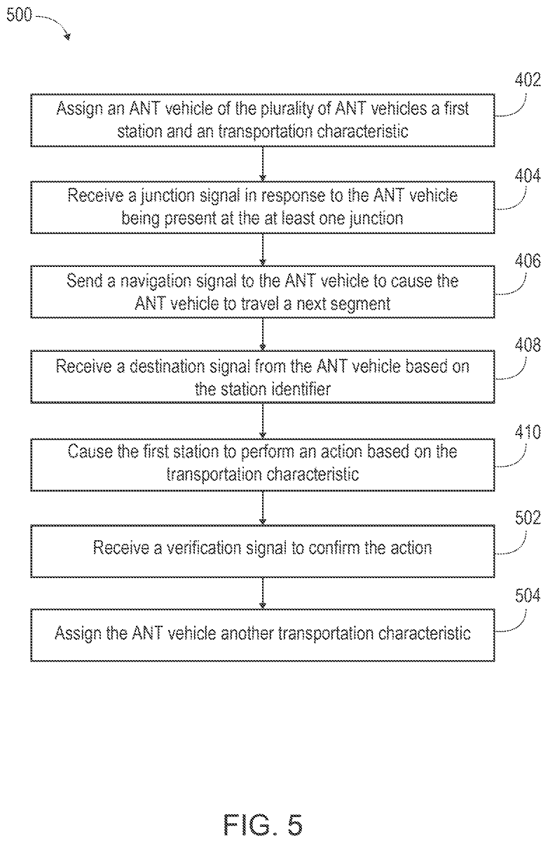

In some embodiments, the ANT vehicle 106 may confirm that the object has been received by the ANT vehicle 106. Turning to FIG. 5, at block 502, the method 500 includes the station module 128 receiving a verification signal to confirm that the action has occurred. For example, the ANT vehicle 106 may use the ANT vehicle systems 146 and/or the ANT vehicle sensors 148 to determine that the ANT vehicle has received an object, such as the 7-inch bowl. In one embodiment, the ANT vehicle sensors 148 may include a weight measuring device, such as a scale. If the action is dispensing an ingredient, for example, salt, the transportation characteristic may be a weight, for example, 6 grams. Based on the measured weight of a received ingredient, the ANT vehicle 106 may send the verification signal indicating whether the ANT vehicle has in fact received 6 grams of salt.

The verification signal may be a binary response either confirming that the action has been performed or that the action has not been performed. In another embodiment, the verification signal may indicate a percentage of the action that has been performed. Continuing the example from above, the verification signal may indicate that 50% of the action has been performed when the ANT vehicle 106 has received 3 grams of salt. The ANT vehicle communications system 144 continues sending verification signals until the transport characteristic has been satisfied, for example, until the ANT vehicle 106 measures a weight of 6 grams.

In another embodiment, the verification signal may be sent by a station 104. For example, suppose that the station is the first ingredient station 222. The station communications system 134 may send a verification signal to the station module 128, to indicate that the first ingredient station 222 will perform, is performing, and/or has performed the action, such as dispensing an ingredient. The verification signal may be based on data from the station systems 136 and/or the station sensors 138 of the station 104. For example, compartments of the first ingredient station may be associated with a weight measuring device. Continuing the example from above, the verification signal may indicate that the first ingredient station 222 has dispensed 6 grams of salt based on the weight measuring device of the first ingredient station 222.

At block 504, the method 500 includes assigning the ANT vehicle 106 another transportation characteristic. For example, in response to receiving the verification signal, the task module 124 may send the ANT vehicle 106 a next task associated with another transport characteristic. The next task may include a different stations or compartment of a station 104. Continuing the example from above, suppose the first transport characteristic is the weight of salt, the second station may be the first ingredient station but with a transport characteristic for another ingredient, such as 3 grams of pepper. In this manner, the ANT vehicle 106 may receive a deploy signal causing the ANT vehicle 106 to move to a next compartment of the first ingredient station 222 or wait at the location for the first ingredient station 222 to dispense a different ingredient.

Alternatively, suppose that the verification signal sent from the ANT vehicle 106 indicates that the ANT vehicle 106 has only received 3 grams of salt when the transportation characteristic indicates 6 grams of salt. The next transportation characteristic may indicate that 3 grams of salt should be collected. In some embodiments, the task module 124 may also assign the ANT vehicle a second stations. Suppose that the first ingredient station 222 has run out of salt, the task module may send a deploy signal causing the ANT vehicle 106 to move to the second ingredient station 224 to collect an additional 3 grams of salt. In this manner, the task module 124 may assign the ANT vehicle 106 another transportation signal and a second station.

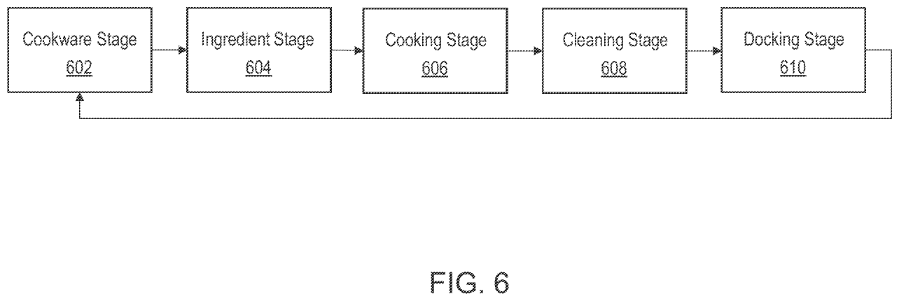

As indicated by FIG. 5, the method of controlling the ANT vehicles may be iterative such that when one task is completed, the task module 124 assigns the ANT vehicle 106 another task. Turning to FIG. 6, the ANT vehicle 106 may move throughout the pathway infrastructure 108 in different stages associated with tasks. For example, suppose the ANT vehicle receives a deploy signal associated with collecting a predetermined amount of sugar in specific type of bowl for a stir-fry at the first cookware station 214 based on a recipe. The task module 124 may transmit deploy signals to the ANT vehicle 106 based on stages.

A first deploy signal may be associated with the cookware stage 602 and sent to cause the ANT vehicle 106 to collect a specific bowl based on a transportation characteristic. For example, the deploy signal may cause the ANT vehicle to approach the first cleaning station 226 to receive the specified bowl. Once the bowl has been collected, the task module 124 may send a second deploy signal associated with an ingredient stage, causing the ANT vehicle 106 to collect the ingredient in the specified bowl. Accordingly, the next stage of the task may cause the ANT vehicle 106 to be sent to a different station. For example, in the ingredient stage 604, the ANT vehicle 106 may move from the first cleaning station 226 to the first ingredient station 222.

The ANT vehicle 106 approaches the next station, here, the first ingredient station 222 once the ANT vehicle 106 receives the second deploy signal to approach with a required bowl type collected from the first cleaning station 226 and with another transportation characteristic. Therefore, each stage may be associated with a transportation characteristic. Continuing the example from above, in the cookware stage 602, the transportation characteristic was a specific type of cookware (i.e., the 7-inch bowl). In the ingredient stage 604, the transportation characteristic may be related to an ingredient (i.e., a particular target weight to be collected).

As discussed above, suppose that the ANT vehicle identifier is an RFID tag, once the junction sensor 166 reads the RFID tag, the junction, where the ANT vehicle 106 is present, activates. For example, suppose that the ANT vehicle 106 is present at the first elevator junction 238. When the RFID tag of the ANT vehicle 106 is read, the first elevator junction 238 activates causing the ANT vehicle 106 to be raised or lowered to a different vertical level. Once the ANT vehicle 106 is at a desired level of storage corresponding to the first station, the ANT vehicle 106 will travel on a path until the ANT vehicle 106 reaches the desires location. For example, the ANT vehicle 106 may travel until the ANT ID reader system 150 detects an expected station identifier where the ANT vehicle 106 stops. For example, suppose the desired ingredient from the task data is salt, when the ANT vehicle 106 reaches an RFID tag on the salt compartment of the first ingredient station, the ANT vehicle 106 stops.

The action at the salt compartment may be dispensing the ingredient. For example, the station module 128 may transmit an object signal that causes a dispensing motor of the compartment to run at a particular speed and/or orientation until the transportation characteristic, here the particular target weight of the ingredient, is dispensed into the bowl already retrieved by the ANT vehicle 106. In some embodiments, the ANT vehicle 106 may transmit a verification signal confirming that the ANT vehicle 106 has received the desired object according to the transportation characteristic. In this manner, the computing device is able to receive feedback based on the transportation characteristic.

In response to receiving the verification signal, the task module 124 may generate a next task in the stage or move to the next stage. For example, the task module 124 may sent a task with the first station and a new transportation characteristic. Suppose the ANT vehicle 106 retrieved salt based on the last task, the task module 124 may assign the ANT vehicle another task to retrieve another ingredient from the first station, such as the first ingredient station 222. The ANT vehicle 106 may ping the task module 124 to determine if further ingredients are to be collected from the first ingredient station 222. Alternatively, the task module 124 may send a task with a second station and a new transportation characteristic. For example, the task module 124 may transmit a task associated with a next stage, such as the cooking stage 606.

Once the collection cycles of the ingredient stage 604 are managed and completed, the task module 124 sends a next deploy signal, here the third deploy signal to cause the ANT vehicle 106 to a particular cooking station, such as the first cookware station 214 in a similar manner as described in the method 400 shown in FIG. 4. For example, the third deploy signal may transmit task data including a station, such as the first cookware station 214, and a new transportation characteristic, different than the transportation characteristic associated with the cookware stage 602 and the ingredient stage 604. Accordingly, the ANT vehicle 106 may move through the pathway infrastructure 108 in a similar manner as described above.

Continuing the example from above, once the ANT vehicle 106 reaches the first cookware station 214, the ANT vehicle 106 will wait, for example, in a dispensing dock located just above the utensils located on the burners associated with the first cookware station 214. The action may cause ANT vehicle 106 to dispense the transported ingredient from the ingredient stage 604. After a verification signal is received from the ANT vehicle 106 and/or the first cookware station 214, the task module 124 may send a task associated with the cleaning stage 608.

In the cleaning stage 608, the task module 124 may send a task for the ANT vehicle 106 to cause the ANT module to return the bowl to the first cleaning station 226. The first cleaning station 226 may contain a soap rinse unit, a fresh water rinse unit, and an air-drying unit. The transportation characteristic associated with the cleaning stage may control the unit where the ANT vehicle 106 deposits the bow. In some embodiments, multiple transportation characteristics may be assigned to the ANT vehicle 106 to cause the ANT vehicle 106 to carry the bowl or other cookware to each of units. Accordingly, multiple transportation characteristics may be sent with the task data to cause the ANT vehicle to make multiple stops at a station, such as the first cleaning station 226, can take multiple actions. In this manner, each transportation characteristic may be associated with an action of the corresponding station.

After finishing the last step of cleaning stage 608, the task module 124 may transmit task data associated with a docking stage 610. The task module 124 may also send the ANT vehicle 106 to the docking stage 610 based on the battery level of the battery 304. The transportation characteristic associated with the docking stage 610 may indicate a particular docking compartment for the ANT vehicle 106 or charge for the ANT vehicle to receive. For example, suppose that the ANT vehicle 106 is initially docked at the first docking station 206. In some embodiments, the ANT vehicle 106 may be docked at the first docking station 206 receiving a charge to reenergize the battery 304 of the ANT vehicle 106. The ANT vehicle 106 would then be ready to begin another work cycle with one or more stages. While the stages 602-610 have been described, a work cycle may include more or fewer stages or the stages may be arranged in a different order, for example, based on the recipe.

In this manner, the computing device 102 provides data and instructions, via the various signals, for monitoring, traversing, collecting, dispensing, and cooking, among other kitchen related activities in the automated kitchen 200. In particular, the device processor 112 and corresponding modules (e.g., the task module 124, the travel module 126, and the station module 128) causes the ANT vehicles, such as the ANT vehicle 106, to transport from one station to another with in an automated kitchen 200. For example, the ANT vehicles may receive ingredient quantities in a designated container type and carry them to an assigned station. The ANT vehicles then travel throughout the automated kitchen on paths of a pathway infrastructure without interfering with other ANT vehicles or activities in the automated kitchen. This approach improves the movement of ingredients in the automated kitchen to be more time efficient, accurate, and organized in a scalable way which results in achieving consistency in cooking.

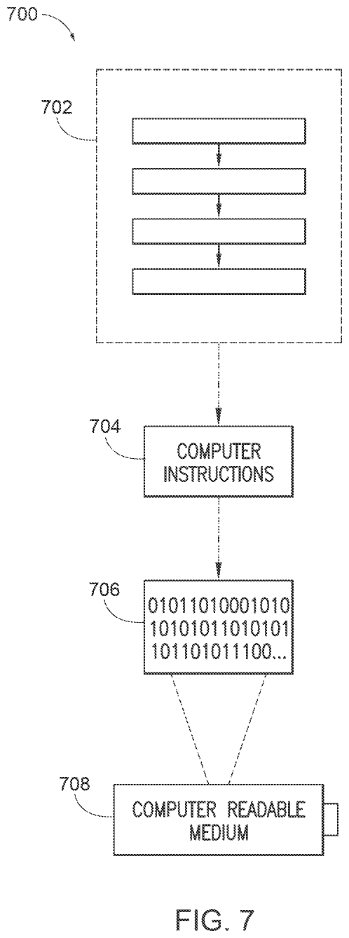

Still another aspect involves a non-transitory computer-readable medium including processor-executable instructions configured to implement one aspect of the techniques presented herein. An aspect of a computer-readable medium or a computer-readable device devised in these ways is illustrated in FIG. 7, wherein an implementation 700 includes a computer-readable medium 708, such as a CD-R, DVD-R, flash drive, a platter of a hard disk drive, etc., on which is encoded computer-readable data 706. This encoded computer-readable data 706, such as binary data including a plurality of zero's and one's as shown in 706, in turn includes a set of processor-executable computer instructions 704 configured to operate according to one or more of the principles set forth herein. In this implementation 700, the processor-executable computer instructions 704 may be configured to perform a method 702, such as the method 400 of FIG. 4, the method 500 of FIG. 5, and the method 600 of FIG. 6. In another aspect, the processor-executable computer instructions 704 may be configured to implement a system, such as the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions is combined or distributed as desired in various environments.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. An autonomous navigation and transportation (ANT) system for an automated kitchen, the ANT system comprising:
a plurality of stations within the automated kitchen, wherein each station of the plurality of stations includes a station identifier;
a plurality of ANT vehicles, wherein each ANT vehicle of the plurality of ANT vehicles includes a machine-readable ANT identifier;
a pathway infrastructure in the automated kitchen forming a plurality of paths having at least one junction where a first path of the plurality of paths intersects a second path of the plurality of paths; and
a computing device configured to:
assign an ANT vehicle of the plurality of ANT vehicles a first station of the plurality of stations associated with at least a first segment of the pathway infrastructure and a transportation characteristic;
receive a junction signal in response to the ANT vehicle being present at the at least one junction;
send a navigation signal to the ANT vehicle to cause the ANT vehicle to travel a next segment from the at least one junction;
receive a destination signal from the ANT vehicle that the ANT vehicle is present at the first station based on the station identifier; and
cause the first station to perform an action relative to the ANT vehicle based on the transportation characteristic.

2. The ANT system of claim 1, wherein the first station includes a plurality of containers having at least one container type of a plurality of container types, and wherein the computing device further assigns the ANT vehicle a container type.

3. The ANT system of claim 1, wherein each station of the plurality of stations is associated with a station category of a plurality of station categories, wherein the plurality of station categories includes a docking station category, an ingredient station category, cooking station category, and cleaning station category.

4. The ANT system of claim 1, wherein the first path and the second path are coplanar, and wherein the at least one junction is a switch junction that separates the first path and the second path.

5. The ANT system of claim 1, wherein the first path is defined by a first plane and the second path is defined by a second plane vertically separated from the first plane, and wherein the at least one junction is an elevator junction that provides vertical transport from the first path to the second path.

6. The ANT system of claim 1, wherein the at least one junction includes a junction identification reader, and wherein the junction signal is received by the computing device in response to the junction identification reader identifying the ANT identifier.

7. The ANT system of claim 1, wherein the ANT vehicle further includes an ANT identification reader, and wherein the destination signal is received by the computing device in response to the ANT identification reader identifying the station identifier.

8. The ANT system of claim 7, wherein the at least one junction includes a junction identifier, and wherein the junction signal is received in response to the ANT identification reader identifying the junction identifier.

9. The ANT system of claim 1, wherein the computing device is further configured to:
receive a verification signal to confirm the action; and
assign the ANT vehicle another transportation characteristic associated with a different action.

10. The ANT system of claim 1, wherein the first station is an ingredient station, the transportation characteristic is a weight of an ingredient, and the action includes the first station dispensing the weight of the ingredient to the ANT vehicle.

11. A computer implemented method for an autonomous navigation and transportation (ANT) system, the computer implemented method comprising:
assigning an ANT vehicle of a plurality of ANT vehicles a first station of a plurality of stations associated with a pathway infrastructure and an transportation characteristic, wherein each ANT vehicle of the plurality of ANT vehicles includes a machine-readable ANT identifier, wherein each station of the plurality of stations includes a machine-readable station identifier; and wherein the pathway infrastructure in an automated kitchen forms a plurality of paths including the first segment and at least one junction where a first path of the plurality of paths intersects a second path of the plurality of pathways;
receiving a junction signal in response to the ANT vehicle being present at the at least one junction;
sending a navigation signal to the ANT vehicle to cause the ANT vehicle to travel a next segment from the at least one junction;
receiving a destination signal from the ANT vehicle that the ANT vehicle is present at the first station based on the station identifier; and
causing the first station to perform an action relative to the ANT vehicle based on the transportation characteristic.

12. The computer implemented method of claim 11, wherein the first path and the second path are coplanar, and wherein the at least one junction is a switch junction that separates the first path and the second path.

13. The computer implemented method of claim 11, wherein the first path is defined by a first plane and the second path is defined by a second plane vertically separated from the first plane, and wherein the at least one junction is an elevator junction that provides vertical transport from the first path to the second path.

14. The computer implemented method of claim 11, further comprising:
receiving an ingredient signal to confirm the action; and
assigning the ANT vehicle another transportation characteristic associated with a different action.

15. A non-transitory computer readable storage medium storing instructions that when executed by a computer having a processor to perform a method for an automated kitchen, the method comprising:
assigning an ANT vehicle of a plurality of ANT vehicles a first station of a plurality of stations associated with a pathway infrastructure and an transportation characteristic, wherein each ANT vehicle of the plurality of ANT vehicles includes a machine-readable ANT identifier, wherein each station of the plurality of stations includes a machine-readable station identifier; and wherein the pathway infrastructure in the automated kitchen forms a plurality of paths including the first segment and at least one junction where a first path of the plurality of paths intersects a second path of the plurality of pathways;
receiving a junction signal in response to the ANT vehicle being present at the at least one junction;
sending a navigation signal to the ANT vehicle to cause the ANT vehicle to travel a next segment from the at least one junction;
receiving a destination signal from the ANT vehicle that the ANT vehicle is present at the first station based on the station identifier; and
causing the first station to perform an action relative to the ANT vehicle based on the transportation characteristic.

16. The non-transitory computer readable storage medium of claim 15, wherein the junction signal includes a junction type of a switch junction or an elevator junction, wherein the switch junction separates the first path and the second path are coplanar, and wherein the elevator junction that separates the first path and the second path and provides vertical transport from the first path to the second path.

17. The non-transitory computer readable storage medium of claim 15, wherein the at least one junction includes a junction identification reader, and wherein the junction signal is received in response to the junction identification reader identifying the ANT identifier.

18. The non-transitory computer readable storage medium of claim 15, wherein the ANT vehicle further includes an ANT identification reader, and wherein the destination signal is received in response to the ANT identification reader identifying the station identifier.

19. The non-transitory computer readable storage medium of claim 18, wherein the at least one junction includes a junction identifier, and wherein the junction signal is received in response to the ANT identification reader identifying the junction identifier.

20. The non-transitory computer readable storage medium of claim 15, further comprising:
receiving an ingredient signal to confirm the action; and
assigning the ANT vehicle another transportation characteristic associated with a different action.
